(19) United States
(12) Patent Application Publication
(10) Pub. No.: US 2006/0192357 A1
(43) Pub. Date: Aug. 31, 2006

(54) Grinding assistance device for skateboards

(76) Inventor: Chorng-Jiang Lin, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/066,210

(22) Filed: Feb. 28, 2005

(51) Int. Cl. B62M 1/00

(52) U.S. Cl. 280/87.042

(57) ABSTRACT

A skateboard includes a deck with two trucks connected to an underside of the deck and each truck has a case with two axles so that two rollers are rotatably connected to the two axles. Two protection members are connected to the two cases respectively and at least one cushion member is connected between respective one of the protection members and respective one of the cases. A rolling shaft is connected each of the two protection members and includes a mediate section which extends out from an opening of the protection member corresponding thereto so as to provide smooth grinding.

### FIELD OF THE INVENTION

The present invention relates to a skateboard having a protection member and a rolling shaft connected to each of the trucks.

### BACKGROUND OF THE INVENTION

A conventional skateboard generally includes a deck with two sets of trucks connected to an underside of the deck and each set of truck includes an axle with two rollers on two ends of the axle. The trucks each include a tubular case in which the axle is received and when the skateboard performs grinding action, the tubular case grinds on the rails or any objects. The case has to be strong enough to bear the impact force and the grinding friction, or the case may be deformed and affects the alignment of the axle. If the axle directly grinds on the rails at one end, the axle could be deformed. Either the tubular case or the axle is deformed, the whole truck has to be replaced with a new one. Besides, in order to have a smooth grinding, users was the underside of the deck and the tubular case and the wax is quickly removed.

The present invention intends to provide a grinding assistance device for a skateboard and includes a rolling shaft connected to each truck and the rolling shaft rolls on rails or objects when the skateboarders grind their skateboards.

### SUMMARY OF THE INVENTION

The present invention relates to a skateboard that comprises a deck with two trucks connected to an underside of the deck and each truck has a case which has two axles so as to respectively connected to two rollers. Two protection members are connected to the two cases respectively and at least one cushion member is connected between respective one of the protection members and respective one of the cases.

Each of the case may have a U-shaped handle connected thereto for convenience of carry. A rolling shaft is rotatably connected to each of the cases so as to roll on rails or objects that the skateboard grinds thereon.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the grinding assistance device and the adjustable device of the present invention;

FIG. 2 is a perspective view to show the combination of the truck and the grinding assistance device of the present invention;

FIG. 3 is a side view to show a skateboard with the grinding assistance device and the adjustable device of the present invention;

FIG. 4 shows the rolling shaft rolls on a rail;

FIG. 5 shows that the adjustable members are located at a first position where the trucks are located close to each other;

FIG. 6 shows that the adjustable members are located at a second position where the trucks are located away to each other;

FIG. 7 shows that the grinding assistance device includes only the protection member and the cushion members, and

FIG. 8 shows a side view of the grinding assistance device in FIG. 7.

### DETAILED DESCRIPTION OF THE PREFERRED EMBODIMENT

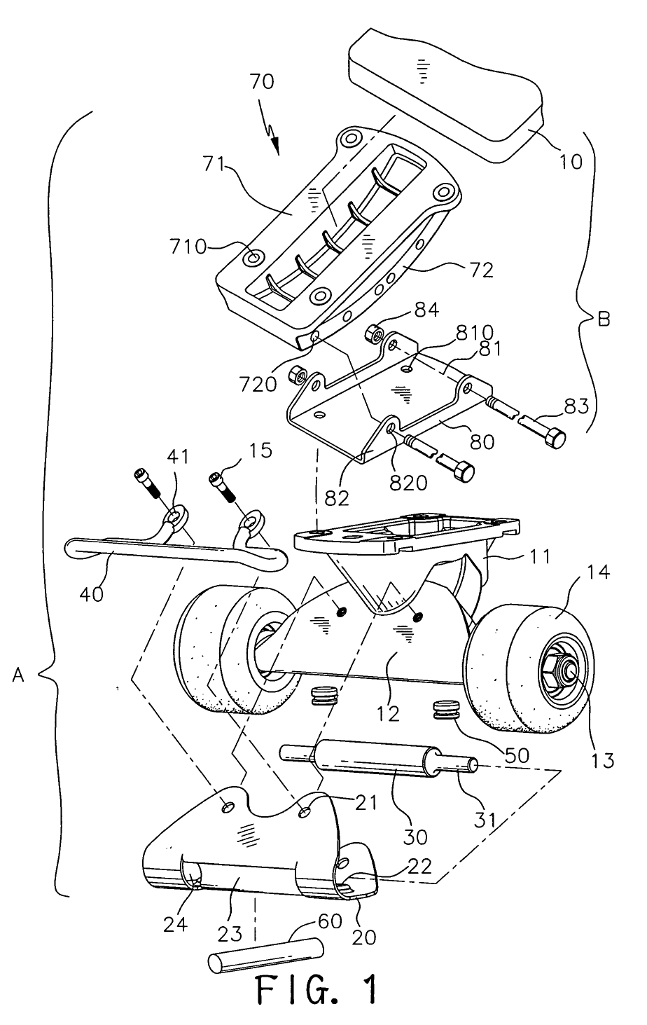

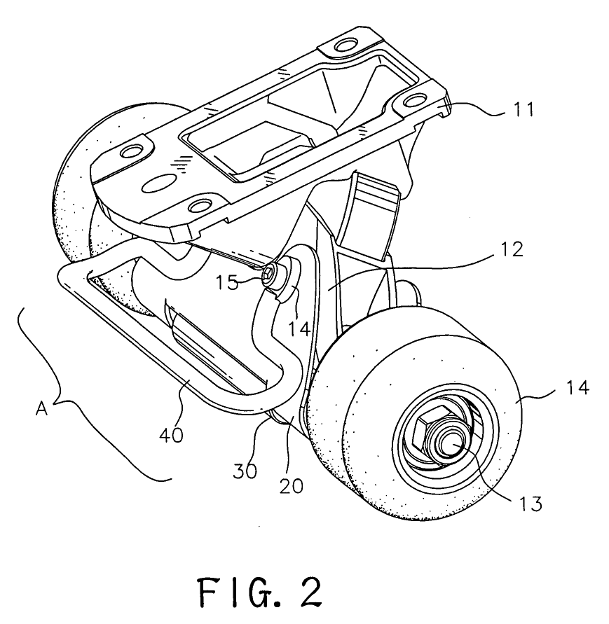

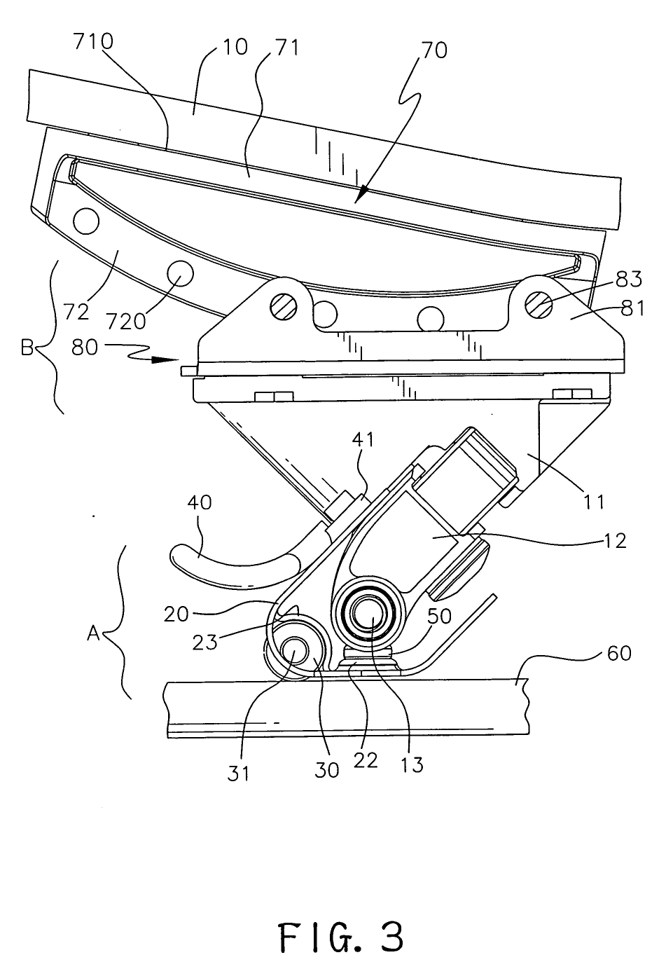

Referring to FIGS. 1 to 3, the skateboard of the present invention comprises a deck 10 with two trucks 11 connected to an underside of the deck 10 and each truck 11 has a case 12 connected thereto. Two axles 13 extend from two ends of the case 12 and two rollers 14 are rotatably connected to the two axles 13 of each case 12. A grinding assistance device “A” is connected to each of the case 12 and each grinding assistance device “A” may include different components such as a protection member 20, a handle 40 and a rolling shaft 30.

Two protection members 20 are connected to the two cases 12 respectively and each protection member 20 is a U-shaped member which is mounted to the case 12. Two support member 22 are located at an inside of each of the U-shaped protection member 20 so as to be connected with two respective ends of two cushion members 50 which are connected between the protection members 20 and the cases 12 to provide cushion feature. The cushion members 50 can be rubbers or springs.

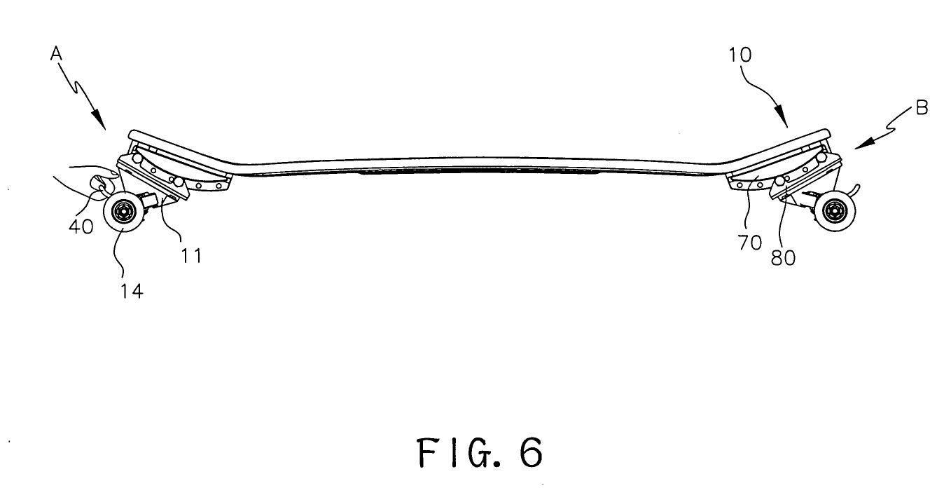

Each of the two protection members 20 has four connection holes 21 so as to be fixed to the two cases 12 by bolts 15. Two U-shaped handles 40 are respectively connected to the two cases 12 and each handle 40 includes two extensions and each extension has a ring 41. The two bolts 15 extend through the rings 41 and are threaded connected to the case 12 to which the handle 40 is connected. As shown in FIG. 6, the users can conveniently grasp the handle 40 to carry the skateboard.

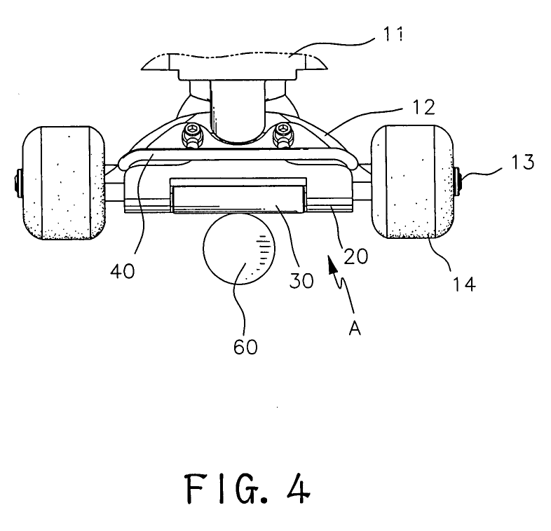

Each of the protection members 20 includes an opening 23 and two frames 24 are located at the protection member 20. The opening 23 is located between the two frames 24. A rolling shaft 30 has tow ends 31 which are rotatably connected to the two frames 24 and a mediate section of the rolling shaft 30 extends out from the opening 23. A diameter of the mediate section of the rolling shaft 30 is larger than that of each of the two ends 31 of the rolling shaft 30 so that the mediate section extends out from the opening 23. It is noted that the rolling shaft 30 is located in parallel to the axles 13 at a proper distance. As shown in FIG. 4, when grinding on a rail 60, the rolling shaft 30 rolls on the rail 60 without worry of possible damage to the case 12 and the axles 13.

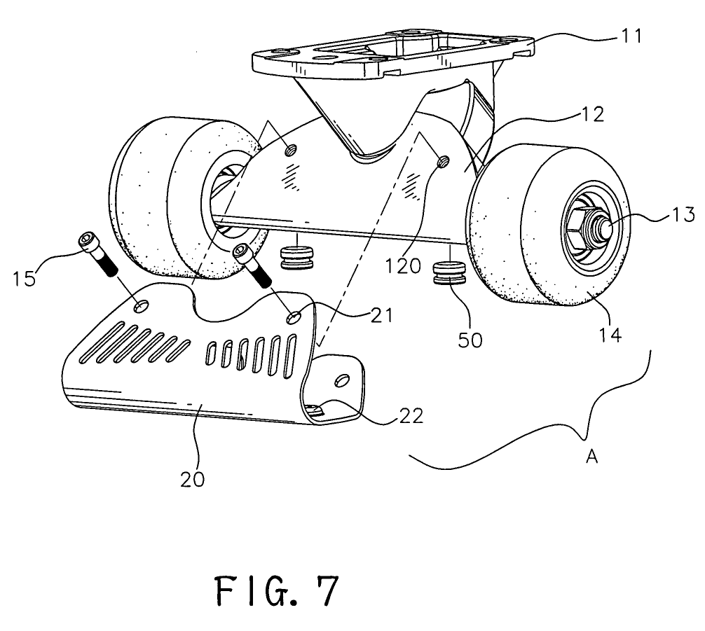

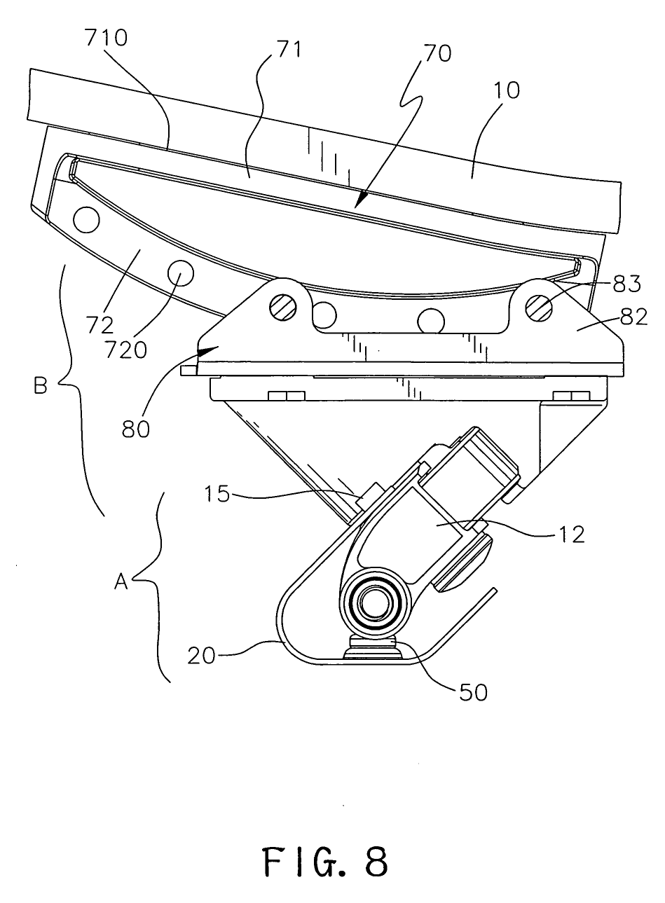

As shown in FIGS. 7 and 8, the grinding assistance device “A” may also be simplified to include only the protection member 20 on each of the case 12 and the protection member 12 is made by durable material so as to grind on the rails or objects.

Further referring to FIGS. 1, 3, 5 and 6, an adjustable device “B” is connected between each truck 11 and the underside of the deck 10. The adjustable device “B” includes a fix plate 80 which is fixed on the truck 11 corresponding thereto by extending bolts (not shown) through holes 810 defined through the fix plate 80 and connected to the top surface of the truck 11. The fix plate 80 includes two lugs 82 extending from each of two sides thereof and each lug 82 includes a hole 820. An adjustable member 70 is fixed to the underside of the deck 10 with it top surface 71 by bolts (not shown) extending through holes 710 in the adjustable member 70 and connected to the deck 10. The adjustable member 70 includes a protrusion 72 extending from an underside thereof and a plurality of connection passages 720 are defined through the protrusion 72. The protrusion 72 is connected between the two pairs of lugs 82 by extending bolts 83 through the holes 820 in the lugs 82 and the connection passages 720 and being connected to nuts 84.

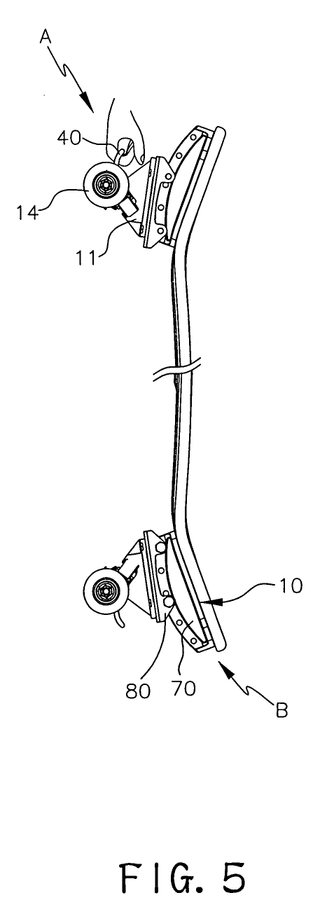

The adjustable member 70 can be fixed to the fix plate 80 at a first position as shown in FIG. 5, where the trucks 11 are located close to each other. At this position, the skateboard is easily controlled to turn and suitable to perform different actions. FIG. 6 shows that the adjustable members 70 are located at a second position where the trucks 11 are located away to each other. At this position, the skateboard is in a stable status and suitable to speed.

While we have shown and described the embodiment in accordance with the present invention, it should be clear to those skilled in the art that further embodiments may be made without departing from the scope of the present invention.

What is claimed is:

1. A skateboard comprising:
a deck with two trucks connected to an underside of the deck, each truck having a case connected thereto and two axles extending from two ends of the case, two rollers rotatably connected to the two axles of each case, and
two protection members connected to the two cases respectively and at least one cushion member connected between respective one of the protection members and respective one of the cases.

2. The skateboard as claimed in claim 1, wherein each of the cases has a handle connected thereto.

3. The skateboard as claimed in claim 2, wherein each handle includes two extensions and each extension has a ring, two bolts extend through the rings and are threaded connected to the case to which the handle is connected.

4. The skateboard as claimed in claim 1, wherein the protection member is a U-shaped member and mounted to the case, at least one support member located at an inside of the U-shaped protection member such that one end of the at least one cushion member is connected thereto.

5. The skateboard as claimed in claim 1, wherein each of the protection members includes an opening and two frames are located at the protection member, the opening is located between the two frames, a rolling shaft has two ends rotatably connected to the two frames and a mediate section of the rolling shaft extends out from the opening.

6. The skateboard as claimed in claim 5, wherein a diameter of the mediate section of the rolling shaft is larger than that of each of the two ends of the rolling shaft.

7. The skateboard as claimed in claim 1, wherein an adjustable device is connected between each truck and the underside of the deck, the adjustable device includes a fix plate fixed on the truck corresponding thereto and an adjustable member which is adjustably connected to the fix plate and the underside of the deck in an elongated direction of the deck.

8. The skateboard as claimed in claim 7, wherein the fix plate includes two lugs extending from each of two sides thereof and the adjustable member includes a protrusion extending from an underside thereof, a plurality of connection passages defined through the protrusion which is connected between the two pairs of lugs by bolts.

9. A skateboard comprising:
a deck with two trucks connected to an underside of the deck, each truck having a case connected thereto and two axles extending from two ends of the case, two rollers rotatably connected to the two axles of each case, and
a rolling shaft connected to each of the cases and being parallel to the axles.

10. The skateboard as claimed in claim 9, wherein two protection members are connected to the two cases respectively and at least one cushion member is connected between respective one of the protection members and respective one of the two cases.

11. The skateboard as claimed in claim 10, wherein each of the protection members includes an opening and two frames are located at the protection member, the opening is located between the two frames, a rolling shaft has two ends rotatably connected to the two frames and a mediate section of the rolling shaft extends out from the opening.

12. The skateboard as claimed in claim 11, wherein a diameter of the mediate section of the rolling shaft is larger than that of each of the two ends of the rolling shaft.

13. The skateboard as claimed in claim 10, wherein each protection member is a U-shaped member and mounted to the case, at least one support member is located at an inside of the U-shaped protection member such that one end of the at least one cushion member is connected thereto.

14. The skateboard as claimed in claim 9, wherein each of the cases has a handle connected thereto.

15. The skateboard as claimed in claim 14, wherein each handle includes two extensions and each extension has a ring, two bolts extend through the rings and are threaded connected to the case to which the handle is connected.

16. The skateboard as claimed in claim 9, wherein an adjustable device is connected between each truck and the underside of the deck, the adjustable device includes a fix plate fixed on the truck corresponding thereto and an adjustable member which is adjustably connected to the fix plate and the underside of the deck in an elongated direction of the deck.

17. The skateboard as claimed in claim 16, wherein the fix plate includes two lugs extending from each of two sides thereof and the adjustable member includes a protrusion extending from an underside thereof, a plurality of connection passages defined through the protrusion which is connected between the two pairs of lugs by bolts.
